(19) United States
(12) Patent Application Publication
(10) Pub. No.: US 2021/0288687 A1
(43) Pub. Date: Sep. 16, 2021

(54) MULTI-FUNCTIONAL PADFOLIO

(71) Applicant: Jayno, LLC, Boise, ID (US)

(72) Inventor: James Russell Novak, Boise, ID (US)

(21) Appl. No.: 17/199,677

(22) Filed: Mar. 12, 2021

Related U.S. Application Data
(60) Provisional application No. 62/989,426, filed on Mar. 13, 2020.

(51) Int. Cl. H04B 1/3888; A45C 15/00; A45C 11/00

(52) U.S. Cl. CPC H04B 1/3888; A45C 15/00; A45C 2011/003; A45C 2200/15; A45C 2011/002; A45C 11/00

(57) ABSTRACT

A multi-functional padfolio is provided herein. The padfolio has a front cover and a back cover, wherein the front cover and back cover are foldably connected via a spine portion. The padfolio has a pen pod detachably affixed to an interior surface of the spine portion, wherein the pen pod is configured to receive at least one pen a foldable stand coupled to an inner surface of the front cover, wherein the foldable stand is securable in at least two positions, a rotatable holder coupled to the foldable stand, wherein the rotatable holder is configured to securely hold an electronic device, a wireless charging pad disposed beneath the inner surface of the front cover, wherein the wireless charging pad is configured to wirelessly charge the electronic device.

### CROSS-REFERENCE TO RELATED APPLICATION

This application claims the benefit of U.S. Provisional Application Ser. No. 62/989,426 entitled Multi-Functional Padfolio filed on Mar. 13, 2020, the entire contents of which are incorporated herein by reference for all purposes.

### FIELD OF THE INVENTION

The invention disclosed herein generally relates to a padfolio. More particularly, the invention disclosed herein relates to a multi-functional padfolio integrated with provisions for business cards, paper refill packs, pen or bills, power banks, rechargeable batteries, and a wireless charging unit for charging the batteries of portable electronic devices.

### BACKGROUND

Journal covers, book covers, padfolios, portfolios, cases, bags, and other business accessories are useful for storing and organizing a variety of accessories and other personal and business effects. Typical modern padfolios include a notepad, a series of pockets and locations for storing various things such as documents, magazines, A4 or letter-sized pads, cards, and pens. More modern padfolios include chargers for cell phones and other form factors.

Padfolio products are in much need for people to strategically organize their belongings. However, existing padfolios lack a well-ordered arrangement of accessories. Further, with changing times, a considerable number of new equipment is available in the market which most people desire to carry with them.

U.S. Pub. No 20170155264 discloses a padfolio having a case and a zipper or a clasp that couples a first portion and a second portion of the case, the first portion and the second portion connected via binding. The padfolio can be folded open to expose an interior. The interior contains a notepad and various sleeves, pockets and compartments useful for storing items such as writing instruments, business cards, paper clips, a calculator, etc.

EP2894045 discloses a freehand writing device for deposit, storage, transport and use of a ring or spiral block having a binding cover. The device further comprises a nickel-metal hydride battery, so that an electronic device such as a digital reader, e-reader, smartphone, tablet or the like can be charged by means of solar cells.

The existing devices utilize charging means that include the use of solar cells to power batteries, which in turn, is connected to a device to charge using wired means such as lightning ports and the like. The batteries in these prior art designs comprise nickel-metal hydride, or lithium-ion so that the electronic device can be charged. However, again, wired connectors for recharging the devices are needed to recharge not only the batteries in the padfolio but also the device that it is connected to. In many of these prior art designs, the size of the battery is large, cumbersome, and heavy. This approach compromises the convenience of having an efficient padfolio that can be carried in an easy manner. Further, the existing prior arts lack to support additional functions that are required in day-to-day activities.

Hence, there is need for a multi-functional device integrated with provision for securing various modern accessories.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

In one embodiment, the padfolio is integrated with provisions for securing various modern accessories and equipment such as, but not limited to, business cards, paper refill packs, pen or bills, power banks, rechargeable batteries, and a wireless charging unit for charging the batteries of portable electronic devices and other form factors. In this way, the pad is useful for promotional products, retail products, industrial products, special markets and government agencies.

A padfolio is provided comprising a front cover and a back cover, wherein the front cover and back cover are foldable, connected via a spine portion, a pen pod detachably affixed to an interior surface of the spine portion, wherein the pen pod is configured to receive at least one pen, a foldable stand coupled to an inner surface of the front cover, wherein the foldable stand is securable in at least two positions, a rotatable holder coupled to the foldable stand, wherein the rotatable holder is configured to securely hold an electronic device, a wireless charging pad disposed beneath the inner surface of the front cover, wherein the wireless charging pad is configured to wirelessly charge the electronic device.

In one embodiment, the padfolio comprises a front cover and a back cover, wherein the front cover and back cover are securely and foldable, connected via a spine portion. The padfolio further comprises a pen pod, a foldable stand having at least two states, namely, an upright state for holding an electronic device such as a smartphone and a flat state for storage when not in use. In its upright state, the stand is secured by a plurality of magnets positioned in the stand and further in in middle of interior of front cover. In its flat state, the stand is secured for storage by a plurality of magnets which may be the same magnets in the stand stick to magnets in bottom of interior of front cover.

The device further comprises a rotatable holder, a wireless charging pad, and an elastic note pad cuff. In one embodiment, the padfolio is made of a material, including but not limited to, leather and leather substitutes. In one embodiment, padfolio is provided with a pen pod that is detachably affixed to an interior surface of the spine portion, wherein the pen pod is configured to securely and seamlessly receive at least one pen. In one embodiment, a foldable stand is affixed to an inner surface of the front cover. The foldable stand comprises a rotatable holder for securely holding an electronic device, for example, a smartphone using a grip. The rotatable holder is formed of an elastomeric material such that is capable of holding smartphones or form factors of different sizes.

In one embodiment, the wireless charging pad is affixed beneath the inner surface of the front cover. The wireless charging pad is configured to wirelessly charge the electronic device, for example, a smartphone. In one embodiment, the elastic note pad cuff is secured to a top portion of the inner surface of the bottom cover. The elastic note pad cuff is configured to securely hold a refillable notepad and also designed to conceal the binding of the notepad with a material that can be made to match the material of the rest of the device. It is also designed to conceal the binding of the notepad with a material that can be made to match the material of the rest of the product, thereby enabling a user to quickly and conveniently take notes and sketches using the refillable notepad.

In one embodiment, the rotatable holder is securely and rotatably affixed to the foldable stand. In one embodiment, the rotatable holder is configured to enable the user to rotate the secured electronic device, for example, a smartphone about 360 degrees either in clockwise or counter-clockwise direction based on the user requirements. The rotatable holder is configured to prop up the electronic device and hold it in place. In one embodiment, the grip is, including but not limited to, a silicon grip. In one embodiment, the electronic device is at least any one of, but not limited to, a smartphone, a personal digital assistant (PDA), and a tablet.

In one embodiment, the wireless charging pad is configured to wirelessly charge the electronic device, for example, a smartphone. The padfolio further comprises a built-in rechargeable power bank for supplying electrical power to the wireless charging pad. Each padfolio is configured with a high capacity 5000 mAh power bank, which is compatible with different electronic devices, for example, IOS and android devices. A wired charger may also be provided.

In operation, the user may place the electronic device, for example, a smartphone on the top of the wireless charging pad. When charging, the electronic device's QI coil is properly aligned with the receiving coil of the wireless charging pad.

In one embodiment, the padfolio is designed for modern professionals and aid users ahead of appointments, schedules, meetings, and interviews, or conventions. In one embodiment, the padfolio is designed with safety mechanisms in order to provide security overcharge protection for keeping the power bank from being charged more than its capacity. In one embodiment, the power bank undergoes rigorous safety and performance tests which align with the standards set by the wireless power consortium (WPC).

In one embodiment, the pen pod is either permanently or detachably affixed to the spine portion. The user may detach the pen pod from the spine portion. In one embodiment, the rotatable holder provided with the grip is secured to the foldable stand. The padfolio further comprises a cord holder which is securely affixed on the inner surface of the front cover. The cord holder is configured to securely hold at least one USB charging cable and/or wired earphones. The elastic note pad cuff is secured to a top portion of the inner surface of the bottom cover. The elastic note pad cuff securely holds the refillable notepad.

In one embodiment, the grip is secured, in operation to the rotatable holder, which is affixed to the foldable stand. In one embodiment, the grip is configured to enable the user to securing the electronic device by extending and pulling the grip over four edges of the electronic device, which leaves the electronic device screen unobstructed during use, thereby allowing the users to simultaneously take notes and sketches on the refillable notepad. The refillable notepad is secured by the elastic note pad cuff.

Optionally, the holder may comprise a magnet rather than a silicone holder and configured to operate with a magnet attachment on a smart device, or a magnet incorporated into a smart device itself. In this way, a user may place the phone on the disc on the device and it would stick to a magnet imbedded underneath said disc. Additionally, the magnet could be configured in conjunction with a wireless charging pad to wireless charge the device as well. In another embodiment, a switch may be incorporated by the charge indicator light to disrupt the flow of electricity to the wireless charger so wireless charging doesn't stay on at all times which may have ill battery effects.

In one embodiment, the padfolio further comprises a charging port, which is configured to enable the user to charge the power bank by connecting to a power supply using an USB cable. In one embodiment, the padfolio further comprises an indicating light, disposed on the inner surface of the bottom cover. The indicating light is configured to indicate the charging level of the power bank. In one embodiment, the indicating light is a light emitting diode (LED). If the indicating light is blinking then the power bank of the padfolio is being charged. When the indicating light stays lit then the power bank is fully charged.

In one embodiment, the pen pod is securely and seamlessly receives a pen. In one embodiment, the pen is fully extended from the pen pod with one push by the user. In one embodiment, the pen is, but not limited to, a spring-loaded pop-up pen. In one embodiment, the pen has a sleek chrome and copper finish to match with a professional wardrobe. In other embodiments, the pen is retained via friction fit, magnets, and the like.

In one embodiment, the pen pod further comprises at least one fastener for detachably affixing to at least any one of a metal surface. The fastener is secured to any one side of the pen pod and may be a magnet or a sticky jelly for example, which is a double-sided adhesive having one side permanently affixed to pen pod and the other side comprises a reusable adhesive so pod can be stuck to a surface, removed, and placed on another surface. When the adhesive weakens, the pod is simply washed with water, let dry, and the adhesive is as strong as when new.

In one embodiment, the padfolio is further configured to receive different type of refillable notepads include, but not limited to, monthly and weekly planner refill, college rules notepad, and a planner goal tracker refill. It is configured to accept a notepad with binding on top of paper or notebook/journal with binding on the side. In this way, the difference is the slit/sleeve on side rather than on top.

In one embodiment, the padfolio is configured to enable the user to quickly and conveniently take notes and/or sketches using the refillable notepad during appointments, schedules, meetings, and interviews, and conventions, etc. using the pen. The user could remove the pen from the pen pod by the spring pop-up mechanism.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a perspective view of a multi-functional padfolio according to an embodiment of the present invention.

FIG. 2 illustrates a perspective view of a foldable stand provided with a rotatable holder for securely holding an electronic device, for example, a smartphone using a grip of the multi-functional padfolio according to one embodiment of the present invention.

FIG. 3 illustrates a wireless charging pad of the multi-functional padfolio according to one embodiment of the present invention.

FIG. 4 illustrate a top view and top perspective view of a multi-functional padfolio according to one embodiment of the present invention.

FIG. 5 illustrate another top view and top perspective view of a multi-functional padfolio according to one embodiment of the present invention

FIGS. 6A and 6B illustrates an electronic device removably secured to the rotatable holder using the grip according to one embodiment of the present invention.

FIG. 7 illustrates a power bank of the multi-functional padfolio charging using an USB cable according to one embodiment of the present invention.

FIG. 8 illustrates a pen pod and a pen of the multi-functional padfolio according to one embodiment of the present invention.

FIGS. 9A-9B illustrate a pen pod provided with a fastener according to one embodiment of the present invention.

FIG. 10 illustrates the multi-functional padfolio provided with a cord holder according to one embodiment of the present invention.

FIG. 11 illustrates a perspective view of the multi-functional padfolio used by the user for taking notes and/or sketches using the refillable notepad during a meeting according to one embodiment of the present invention.

FIG. 12 illustrates a bottom perspective view of the multi-functional padfolio according to one embodiment of the present invention.

FIG. 13 illustrates a perspective view of the multi-functional padfolio provided with a built-in holder or pocket according to one embodiment of the present invention.

FIGS. 14A-14D illustrate different fastening mechanism of pen pod according to an optional embodiment of the present invention.

FIGS. 15A-15D illustrate a pen pod attachment using different fastening mechanisms according to one embodiment of the present invention.

FIGS. 16A-16B illustrate a universal penholder or universal pen pod according to the preferred embodiment of the present invention.

FIGS. 17A-17D illustrate the universal pen holder or universal pen pod according to embodiments of the present invention.

FIG. 18 illustrates an exploded view of the multi-functional padfolio according to embodiments of the present invention.

FIG. 19 illustrates a multi-ringed binder attached to the multi-functional padfolio according to an embodiment of the present invention.

FIG. 20 illustrates a perspective view of the multi-functional padfolio provided with multiple built-in holders or pockets for tools according to one embodiment of the present invention.

FIG. 21 illustrates a perspective view of the multi-functional padfolio provided with multiple built-in holders or pockets for makeup and cosmetic tools according to one embodiment of the present invention.

FIG. 22 illustrates a multiple perspective views of a pen pod and a pen of the multi-functional padfolio according to one embodiment of the present invention.

### DETAILED DESCRIPTION OF EMBODIMENTS

The following description is presented to enable any person skilled in the art to make and use the invention, and is provided in the context of a particular application and its requirements. Various modifications to the disclosed embodiments will be clearly apparent to those skilled in the art, and the general principles defined herein is applied to other embodiments and applications without departing from the scope of the present invention. Thus, the present invention is not intended to be limited to the embodiments shown but is to be accorded the widest scope consistent with the principles and features disclosed herein. The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described are shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be also understood to refer to functional equivalents of such structures. The present invention will now be described in detail with reference to embodiments thereof as illustrated in the accompanying drawings.

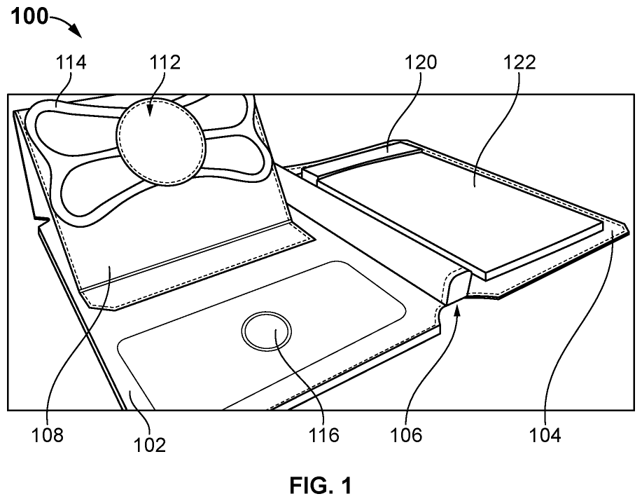

Referring to FIG. 1, a perspective view of a multi-functional padfolio 100 in one embodiment is disclosed. In one embodiment, the padfolio 100 is integrated with provisions for securing various modern accessories and equipment such as, but not limited to, business cards, paper refill packs, pen or bills, power banks, rechargeable batteries, and a wireless charging unit for charging the batteries of portable electronic devices, etc.

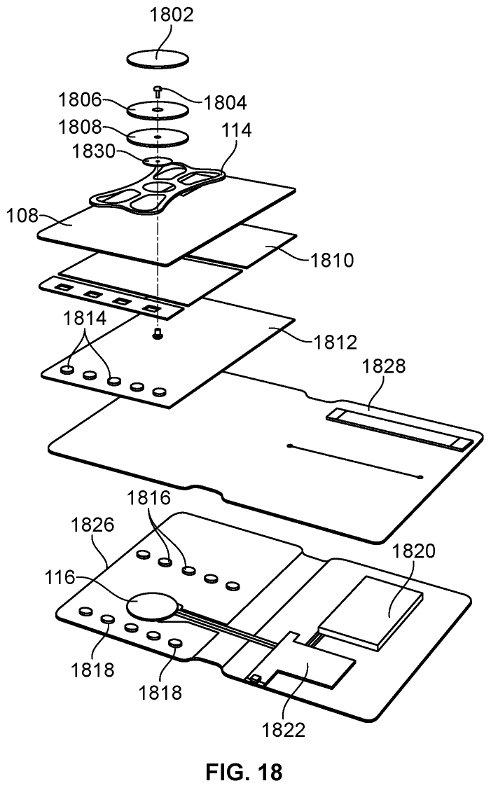

In one embodiment, the padfolio 100 comprises a front cover 102 and a back cover 104, wherein the front cover 102 and back cover 104 are securely and foldably connected via a spine portion 106. In one embodiment, the padfolio 100 further comprises a pen pod 110 (shown in FIG. 4), a foldable stand 108, a rotatable holder 112, a wireless charging pad 116, a power bank (shown in FIG. 18), and an elastic note pad cuff 120. The pen pod 110 is permanently or detachably affixed to an interior surface of the spine portion 106 and is configured to securely and seamlessly receive at least one pen 118 (shown in FIG. 4).

Referring still to FIG. 1, a foldable stand 108 is affixed to an inner surface of the front cover 102. The foldable stand 108 comprises a rotatable holder 112 for securely holding an electronic device 124, for example, a smartphone using a grip 114. The grip 114 is rotatable around the holder 112 in this way. The wireless charging pad 116 is affixed beneath the inner surface of the front cover 102. The wireless charging pad 116 is configured to wirelessly charge the electronic device 124, for example, a smartphone. In one embodiment, the elastic note pad cuff 120 is secured to a top portion of the inner surface of the bottom cover 104. The elastic note pad cuff 120 is configured to securely hold a refillable notepad 122, thereby enabling a user to quickly and conveniently take notes and sketches using the refillable notepad 122. Furthermore, as describe in greater detail with reference to FIG. 18, a magnet or a magnet array is disposed inside the front cover to secure the foldable stand in at least two secured positions, upright and flattened/stored. The magnet configuration is shown in detail in FIG. 18.

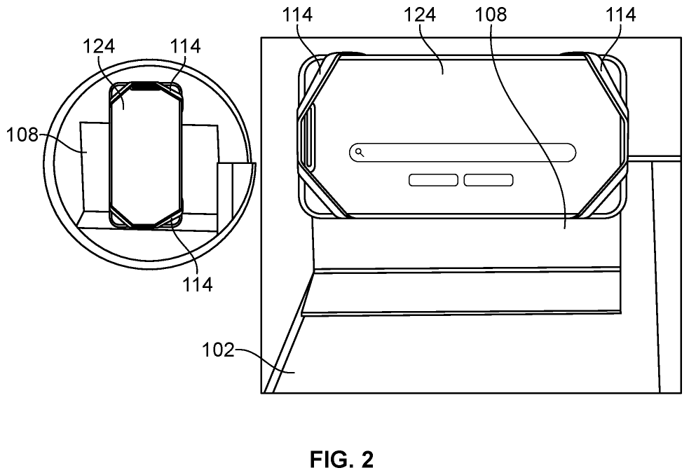

Referring to FIG. 2, the foldable stand 108 provided with a rotatable holder 112 for securely holding the electronic device 124 using the grip 114 in one embodiment is disclosed. In one embodiment, the rotatable holder 112 is securely and rotatably affixed to the foldable stand 108. In one embodiment, the rotatable holder 112 is configured to enable the user to rotate the secured electronic device 124, for example, a smartphone about 360 degrees either in clockwise or counter-clockwise direction based on the user requirements. The foldable stand 108 props up the electronic device 124 and the rotatable holder 112 holds it in place. In one embodiment, the grip 114 is, but not limited to, a silicon grip. In one embodiment, the electronic device 124 is at any one of, but not limited to, a smartphone, a personal digital assistant (PDA), and a tablet. As described with relation to FIG. 18, a magnet or array of magnets may take the place of the holder 112 and hold or secure magnet enabled smart devices in place.

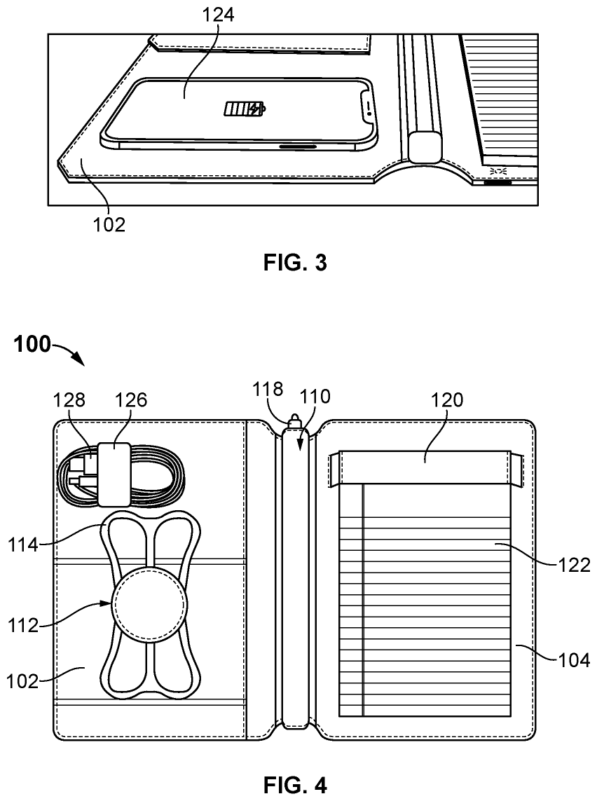

Referring now to FIG. 3, the wireless charging pad 116 of the padfolio 100 used for charging the electronic device 124, for example, a smartphone in one embodiment is disclosed. In one embodiment, the wireless charging pad 116 is configured to wirelessly charge the electronic device 124, for example, a smartphone. The padfolio 100 further comprises a built-in rechargeable power bank for supplying electrical power to the wireless charging pad 116. Each padfolio is configured with for example a safe and high capacity 5000 mAh power bank for example, which is compatible with different electronic devices, for example, IOS and android devices.

In operation, the user may place the electronic device 124, for example, a smartphone on the top of the wireless charging pad 116 (shown in FIG. 1). When charging, make sure that the electronic device's 124 QI coil properly aligned with the receiving coil of the wireless charging pad 116.

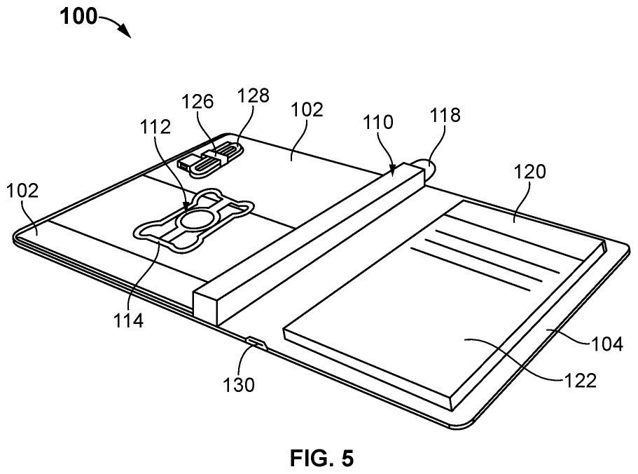

Referring to FIGS. 4 and 5, the multi-functional padfolio 100 of the present invention in one embodiment is disclosed. In one embodiment, the padfolio 100 is designed for modern professionals and aid users ahead of appointments, schedules, meetings, and interviews, or conventions. In one embodiment, the padfolio 100 is designed with safety mechanisms in order to provide security overcharge protection for keeping the power bank from being charged more than its capacity.

Referring still to FIGS. 4 and 5, the pen pod 110 is either permanently or detachably affixed to the spine portion 106. The user could simply detach the pen pod 110 from the spine portion 106. One or more pen pods could be placed within the cover on disposed in other areas of the book. For example, instead of in the binding, the pen pod could be placed on the edge of the interior of the front or back cover, or on the top and bottom. In one embodiment, the rotatable holder 112 provided with the grip 114 is secured to the foldable stand 108. In one embodiment, the padfolio 100 further comprises an accessory holder 126, which is securely affixed on the inner surface of the front cover 102. In one embodiment, the cord holder 126 is, but not limited to, an elastic holder. The cord holder 126 is configured to securely hold at least one USB charging cable and/or wired earphones 128. In one embodiment, the elastic note pad cuff 120 is secured to a top portion of the inner surface of the bottom cover 104. The elastic note pad cuff 120 securely holds the refillable notepad 122.

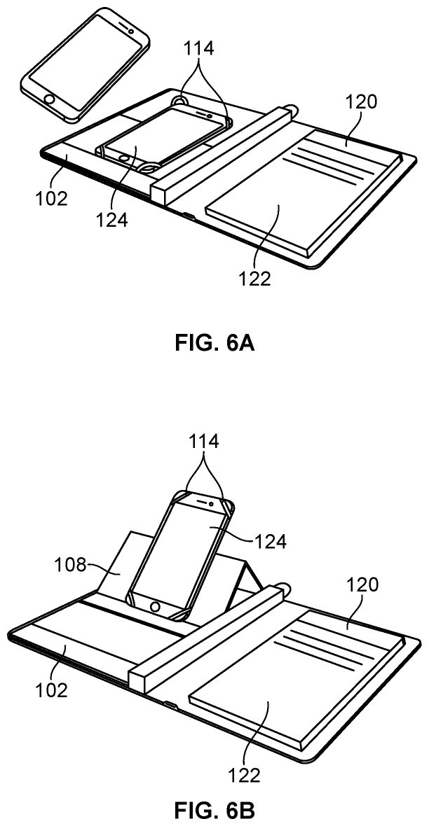

Referring to FIGS. 6A-6B, the electronic device 124 is removably secured to the rotatable holder 112 using the grip 114 is illustrated. In one embodiment, the grip 114 is secured to the rotatable holder 112, which is affixed to the foldable stand 108. The grip 114 is configured to enable the user to secure the electronic device 124 by extending and pulling the grip 114 over four edges of the electronic device 124, which leaves the electronic device 124 screen unobstructed during use, thereby allowing the users to simultaneously take notes and sketches on the refillable notepad 122. The refillable notepad 122 is secured by the elastic note pad cuff 120. In embodiments, the grip 114 is an elastomeric material that allows a myriad of different devices to be secured.

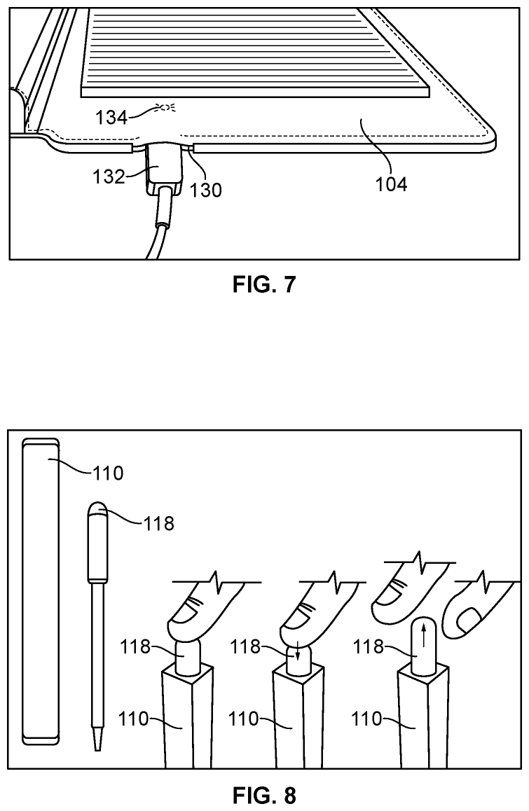

Referring now to FIG. 7, the power bank of the padfolio 100 is shown charged using an USB cable 132 in one embodiment. In one embodiment, the padfolio 100 further comprises a charging port 130, which is configured to enable the user to charge the power bank by connecting to a power supply using an USB cable 132. In one embodiment, the padfolio 100 further comprises an indicating light 134, disposed on the inner surface of the bottom cover 104. The indicating light 134 is configured to indicate the charging level of the power bank. In one embodiment, the indicating light 134 is a light emitting diode (LED). If the indicating light 134 is blinking then the power bank of the padfolio 100 is being charged. When the indicating light 134 stays lit then the power bank is fully charged and should be immediately disconnected from the power source. In embodiments, as discussed with relation FIG. 18, an IC board may be turned off to interrupt electricity to charging pad.

Referring now to FIG. 8, the pen pod 110 and the pen 118 of the padfolio 100 is illustrated. In one embodiment, the pen pod 110 securely and seamlessly receives at least one pen 118. In one embodiment, the pen 118 is fully extended from the pen pod 110 with one push by the user. The pen 118 is, but not limited to, a spring-loaded pop-up pen. In embodiments, the pen pod may integrate with post-it flag dispensers, a Bluetooth® speaker or microphone, and an additional pen on the bottom so that the pen pod holds two pens.

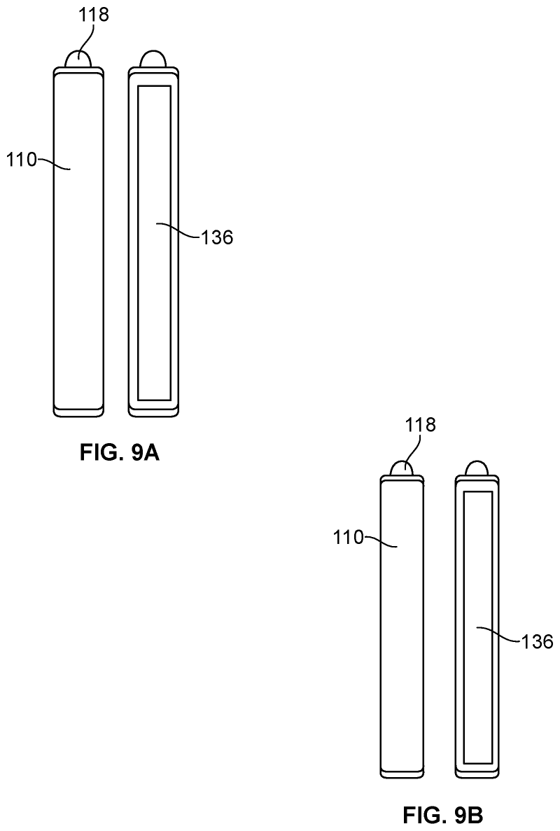

Referring to FIGS. 9A-9B, the pen pod 110 provided with a fastener 136 in an optional embodiment. In one embodiment, the pen pod 110 further comprises at least one fastener 136 for detachably affixing to a surface. In one embodiment, the fastener 136 is secured to any one side of the pen pod 110. In one embodiment, the fastener 136 is, but not limited to, a magnet or a sticky jelly. In one embodiment, the length of the pen pod 110 is ranges from about, but not limited to, 4 to 4.3″.

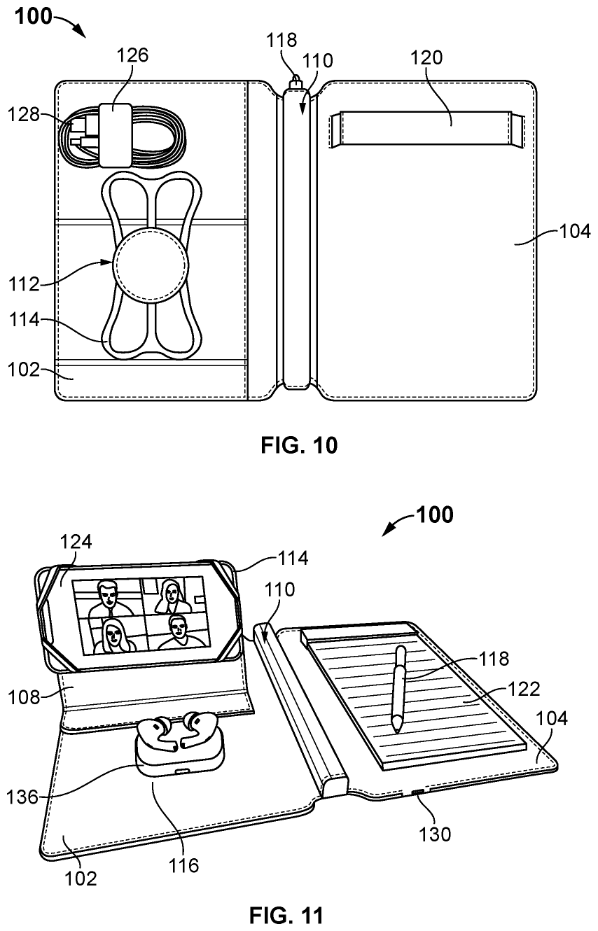

Referring now to FIG. 10, the multi-functional padfolio 100 is provided with a cord holder 126 of the present invention. In one embodiment, the padfolio 100 is further configured to receive different type of refillable notepads include, but not limited to, monthly and weekly planner refill, college rules notepad, and a planner goal tracker refill. In one embodiment, the pen pod 110 is, but not limited to, a retractable pen pod. In one embodiment, the rotatable holder 112 provided with the grip 114 is secured to the font cover 102. In one embodiment, the cord holder 126 is securely affixed on the inner surface of the front cover 102 for securely holding at least one USB cable 128. In one embodiment, the elastic note pad cuff 120 is configured to securely hold at least one refillable notepad 122.

Referring to FIG. 11, a perspective view of the multi-functional padfolio 100 used by the user for taking notes and/or sketches using the refillable notepad 122 during a meeting in one embodiment is illustrated. The padfolio 100 is configured to enable the user to quickly and conveniently take notes and/or sketches using the refillable notepad 122 during appointments, schedules, meetings, and interviews, and conventions, etc. using the pen 118. The user may remove the pen 118 from the pen pod 110 by the spring pop-up mechanism. The electronic device 124, for example, a smartphone is securely and rotatably affixed to the rotatable holder 112 with the grip 114.

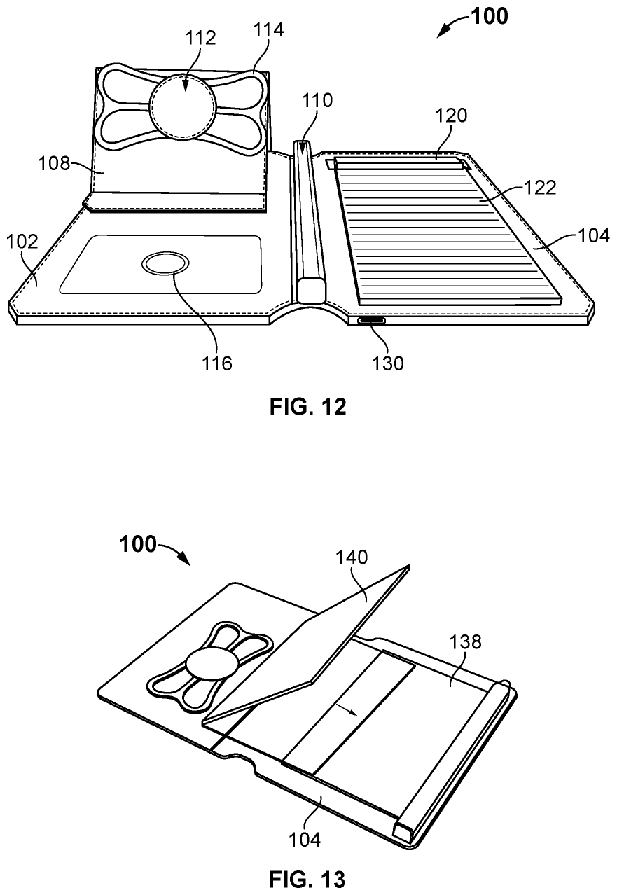

Referring to FIGS. 12-13, the multi-functional padfolio 100 of the present invention is disclosed. In operation, the user may secure the refillable notepad 122 to the elastic note pad cuff 120. Further, the user may secure the smartphone to the rotatable holder 112 using the grip 114. In one embodiment, the padfolio 100 further comprises at least one built-in holder or pocket 138, which is provided on the inner surface of the bottom cover 104. The built-in holder or pocket 138 is configured to receive at least one journal or a planner. In other embodiments, the journal or notepad may be secured with magnets disposed in the cover and interact with magnets on the notepad or journal as described in relation to FIG. 18.

In one embodiment, the padfolio 100 is provided with a cover that is made of, but not limited to, leather and animal friendly faux leather. In one embodiment, the padfolio 100 is provided with a hot foil stamping, embossing, holographic foil, and engraving and gold stamping, wrinkle effect, and a micro texture.

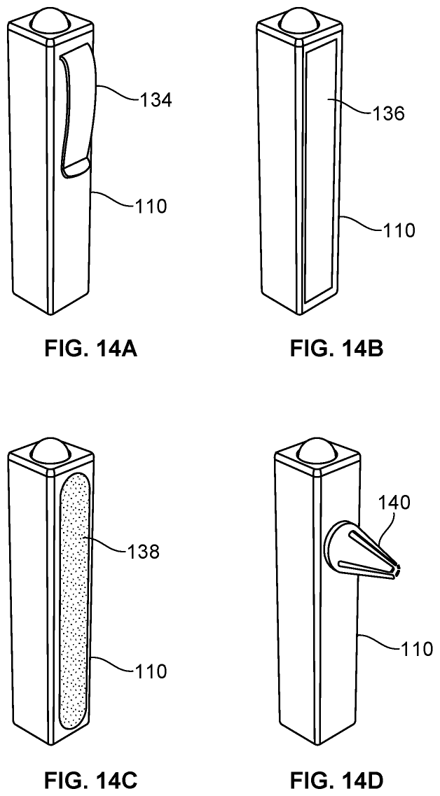

FIGS. 14A-14D illustrate optional fastening mechanism of pen pod 110 according to an optional embodiment of the present invention. In this embodiment, pen pod 110 secures the pen 118 and comprises a clip 134 for attachment with any objects. In an optional embodiment, the pen pod 110 is attached to any sticking surfaces using magnet 136 of the pen pods 110. In another embodiment, the pen pod 110 comprises a hook and loop fastener (Velcro®) 138 for fastening purpose. A vent clip 140 is integrated with the ped pod 110 for fastening purpose.

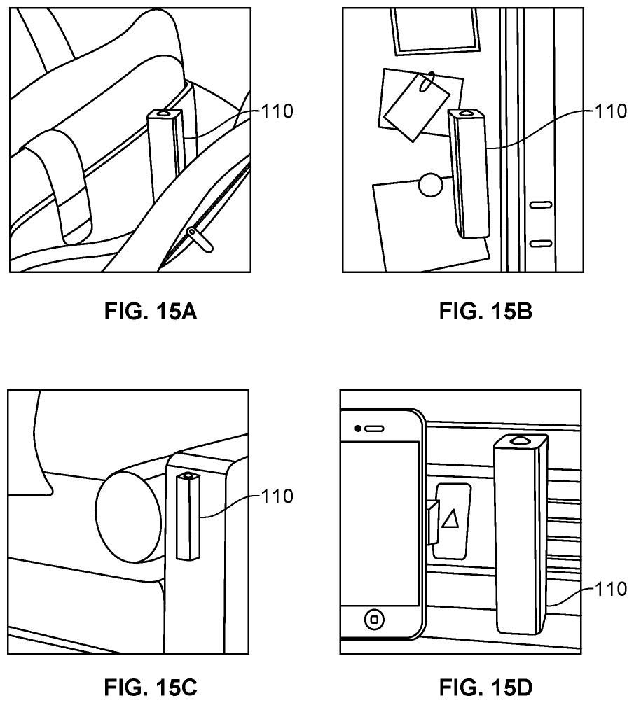

FIGS. 15A-15D illustrate pen pod 110 attachment using different fastening mechanism, as illustrated in FIGS. 14A-14D. The pen pod 110 is securely attached to any bag like structure using the clip 134. The pen pod 110 having magnet 136 could stick to any metal surfaces. The pen pod 110 having hook and loop fastener (Velcro®) 138 is attached to furniture or any furnishing articles. Using the vent clip 140 the pen pod 110 is secured to a front portion of the car.

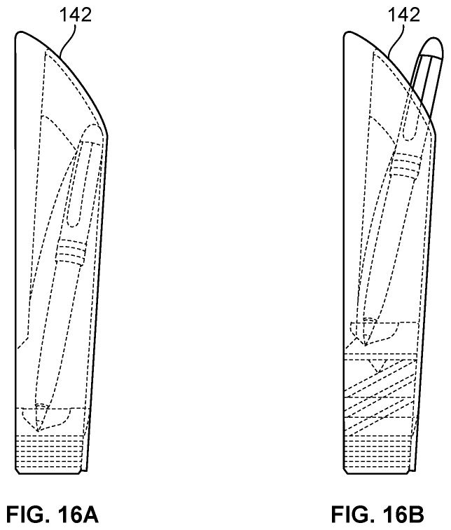

FIG. 16A and FIG. 16B illustrate a universal penholder or universal pen pod 142 according to the preferred embodiment of the present invention. The universal pen holder 142 holds a constant pressure on the pen. The universal pen pod 142 is configured with a spring pop-up mechanism at the bottom to accommodate any type of pen. In one embodiment, the pen is any pen, but not limited to, an existing pen available in the market. In some embodiments, the universal pen holder 142 is retrofittable to any objects, but not limited to, padfolio.

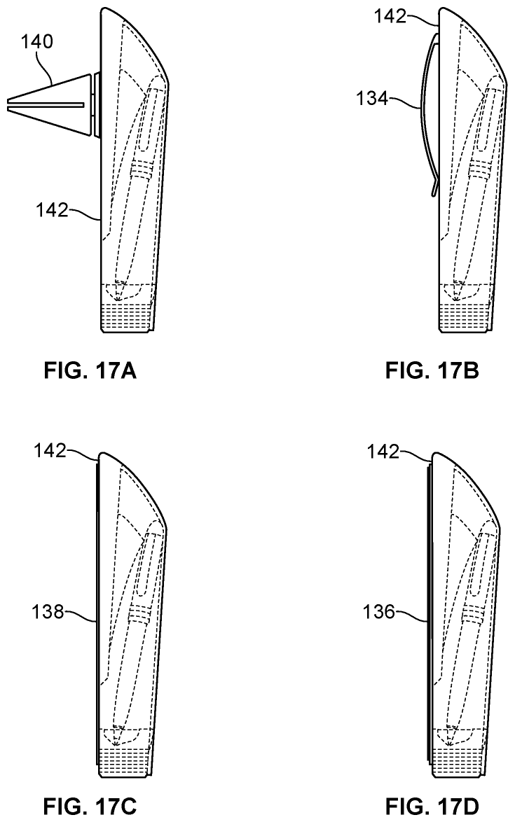

FIGS. 17A-179D illustrate the universal pen holder or universal pen pod 142 according to an optional embodiment of the present invention. The universal pen holder 142 is incorporated with the clip 134, the magnet 136, the hook and loop fastener (Velcro®) 138, or the vent clip 140.

Referring now to FIG. 18, an exploded view of the multi-functional padfolio according to an embodiment of the present invention is shown. The exploded view shows the padfolio elements internally and externally. Starting from the top, As can be seen, a device pad 1802 is provided and configured to have a device laid on it or resting on it (in an upright position). The device may be made of a PU leather for example. The device pad 1802 is connected to one or more rigid discs 1806 and 1808 to provide rigidity. A lower disc 1830 has approximately the same thickness as the grip and approximately the same diameter as the circular opening in the grip so that lower disc 1830 fits within the grip. This allows rotation of the grip 114 around lower disc 1830. The grip 114 may be an elastomeric material that allows a myriad of different devices to be secured. As shown, the grip 114 is attached to the stand 108 (shown in flattened state) which is supported by a rigid board 1810. A fastener, such as a Chicago screw 1804, rivet or nail, connects 1804, 1808, 1830, 108, and 1810. Underneath rigid board 1810 and the fastener 1804, a fabric or other material 1812 is disposed. The rigid board 1810 may defined in three-piece construction so that it can properly fold into an upright state. 108 and 1812 are sewn or otherwise connected together with components 1810, the bottom portion of fastener 1804, and 1814 sandwiched in between. The foldable stand 108 may be sewn to the top of front cover interior, but could be sewn to bottom of front cover interior as well.

In another embodiment, the plurality of discs may be replaced with a magnet assembly and/or QI charging pad so that a magnet-enabled device would stick to the disc and charge with no need for the grip.

An array of magnets 1814 are provided toward a lower portion of a fabric layer 1812 making them an internal component of the foldable stand 108. The array of magnets 1814 are a top array of magnets that connect to one of two sets of magnets in the front cover 1816 or 1818 to keep the foldable stand in an upright position (magnets 1814 connect to magnets 1816) or flattened state (magnets 1814 connect to magnets 1818). An inner cover 1828 is provided to act as a cover to the outer cover 1826 which houses a plurality of electronic components, additional arrays of magnets, and rigid elements to provide rigidity. The electronic components comprise the QI charging pad 116 affixed to the inside front cover, and in electronic communication with the IC board 1822 and a power bank 1820. The power bank 1820 may be charged in any known or currently unknown way and may further comprise a plurality of batteries. The inside front cover may further comprise a plurality of embedded magnets 1816 on an upper portion and additional array of magnets 1818 on a lower portion. Inner cover 1828 and outer cover 1826 are sewn or otherwise affixed together sandwiching components 1816, 1818, 1822, 1829, 1830, 1832, 116 in between. Though not shown in this view, the pen pod is then affixed permanently or detachably down the center spine of 1828.

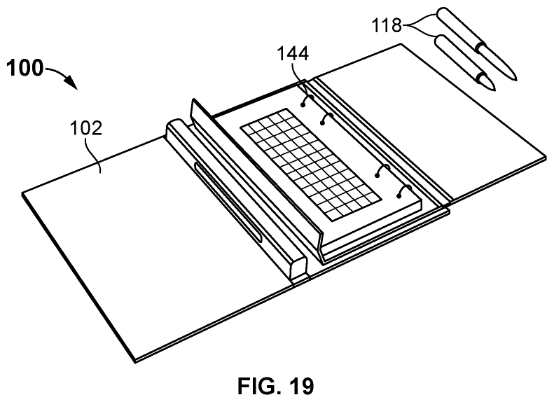

FIG. 19 illustrates incorporating a multi-ringed binder 144 attached to the multi-functional padfolio 100 according to an embodiment of the present invention. The padfolio 100 comprises a multi-ringed binder 144 hold a notepad of letter-size (8.5×11 inches), legal-size (8.5×14 inches) or A4 size (8.27×11 inches). Auditor notebook, sales clerk, pilot logbook, estimator workbooks, auto service writer etc. is secured to the padfolio 100 using the multi-ringed binder 144. The multi-ringed binder 144 is, secured against the interior of the padfolio 100 and conveniently accessed for writing notes using pen 118. While the covering case 102 of the padfolio 100 shown with various items, sleeves, pockets, and compartments, it is to be understood that the covering case 102 is given for illustrative purposes only and that another structure and arrangement may suffice.

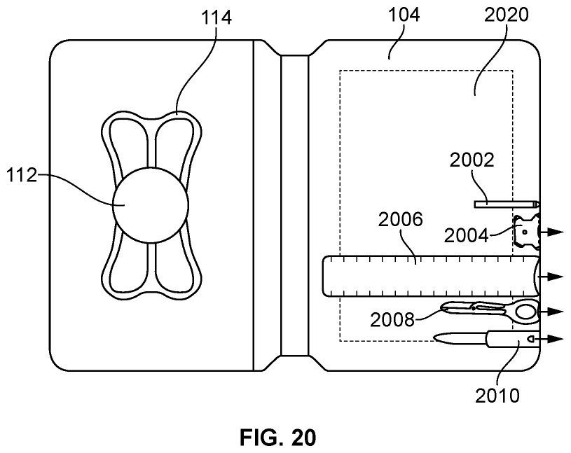

Referring now to FIG. 20, a perspective view of the multi-functional padfolio provided with multiple built-in holders or pockets for tools according to one embodiment of the present invention. The padfolio, in this embodiment includes a portion 2020 with multiple pockets or slots that may house, for example, tweezers 2002, screw driver 2004, ruler 2006, scissors 2008 and a knife or letter opener 2010. The pockets hold the tools so that they are almost completely concealed between the outer cover 1826 and inner cover 1828 and hidden out of sight until ready for use whereby the user would slide a given tool out of the holder.

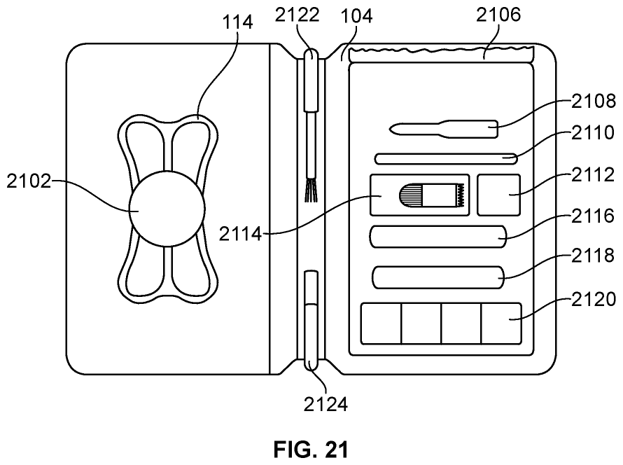

FIG. 21 illustrates a perspective view of the multi-functional padfolio provided with multiple built-in holders or pockets for makeup and cosmetic tools according to one embodiment of the present invention. The padfolio, in this embodiment includes a portion 2120 with multiple pockets or slots that may house, for example, nail file 2108, eyeliner 2110, blush 2112, brush 2114, foundation 2116, mascara 2118, and makeup compartment 2120. Furthermore, the smart device holder at 2102 may comprise a mirror, or there may be a hinged lid with a mirror at 2106. The spine may also include a pen pod adapted to items such as lipstick 2124 or make up brush 2122.

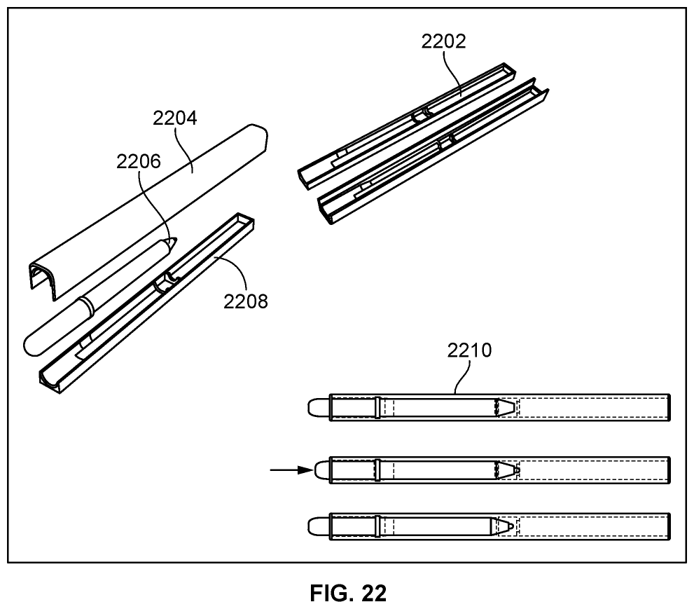

FIG. 22 illustrates a multiple perspective views of a pen pod and a pen of the multi-functional padfolio according to one embodiment of the present invention. In this embodiment of the pen pod comprises a U-shaped holder 2204 such that a portion of the padfolio makes up the fourth the side of the pod. In this way the pen 2206 is inserted in the open top and is held in the interior portion 2202 via a friction fit using a fabric strip on the inside, top and bottom, for example, or any other type of spring or magnetic fit for easy accessibility. Wall 2208 makes up a side of the pod.

The foregoing examples have been provided merely for the purpose of explanation and are in no way to be construed as limiting of padfolio 100, disclosed herein. While the padfolio 100 has been described with reference to various embodiments, it is understood that the words, which have been used herein, are words of description and illustration, rather than words of limitation. Further, although the padfolio 100 has been described herein with reference to particular means, materials, and embodiments, the padfolio 100 is not intended to be limited to the particulars disclosed herein; rather, the padfolio 100 extends to all functionally equivalent structures, methods and uses, such as are within the scope of the invention. Although there has been shown and described the preferred embodiment of the present invention, it will be clearly apparent to those skilled in the art that modifications is made thereto which do not exceed the scope of the invention.

What is claimed is:

1. A padfolio comprising:
a front cover and a back cover, wherein the front cover and back cover are connected via a spine portion;
a pen pod detachably affixed to an interior surface of the spine portion, wherein the pen pod is configured to receive at least one pen;
a foldable stand coupled to an inner surface of the front cover, wherein the foldable stand is securable in at least two positions;
a rotatable holder coupled to the foldable stand, wherein the rotatable holder is configured to securely hold an electronic device;
a wireless charging pad disposed beneath the inner surface of the front cover, wherein the wireless charging pad is configured to wirelessly charge the electronic device.

2. The padfolio of claim 1, further comprising:
a first magnet provided at a lower portion of the front cover;
a second magnet provided at an upper portion of the front cover;
a third magnet disposed in the foldable stand, wherein the third magnet is configured to couple to the first magnet so that the stand is in a flatted position, wherein the third magnet is configured to couple to the second magnet so that the stand is in an upright position.

3. The padfolio of claim 2, wherein the first magnet and second magnet are embedded in the front cover, and wherein the third magnet is embedded in the stand.

4. The padfolio of claim 1, further comprising:
a device pad configured for the electronic device to rest on it; and
wherein the rotatable holder comprise at least one rigid disc coupled to and positioned beneath the device pad, wherein the rigid disc is configured to allow rotation of the grip about the holder.

5. The padfolio of claim 4, wherein the grip is a magnet assembly configured to couple to magnet-enabled smart devices.

6. The padfolio of claim 1, wherein the pen pod is a retractable pen pod.

7. The padfolio of claim 1, wherein the pen pod further comprises a fastener for detachably affixing to at least any one of a metal surfaces, clothes, bags, furniture, and/or a front portion or a dashboard of a vehicle.

8. The padfolio of claim 1, wherein the fastener is at least any one of a magnet, a hook and loop fastener, a clip, a vent clip, or a sticky jelly.

9. The padfolio of claim 1, wherein the rotatable holder is securely and rotatably affixed to the foldable stand, wherein the rotatable holder is configured to enable the user to rotate the secured electronic device about three hundred and sixty degrees either in clockwise or counter-clockwise direction based on the user requirements.

10. The padfolio of claim 1, wherein the electronic device is at least any one of a smartphone, personal digital assistant (PDA), and a tablet.

11. The padfolio of claim 1, further comprising a power bank positioned under the inner surface of the front cover or back cover, wherein the power bank is electrically connected to the wireless charging pad for supplying electrical power.

12. The padfolio of claim 1, further comprises a charging port, wherein the charging port is configured to enable the user to charge the power bank by connecting to a power supply using an USB cable.

13. The padfolio of claim 1, further comprising:
an indicating light disposed on the inner surface of the bottom cover, wherein the indicating light is configured to indicate the charging level of the power bank;
a switch incorporated into the cover and configured to disrupt a flow of electricity to the wireless charger.

14. The multi-functional padfolio of claim 13, the indicating light is a light emitting diode (LED).

15. The multi-functional padfolio of claim 1, wherein the grip is configured to enable the user for securing the electronic device by extending and pulling the grip over four edges of the electronic device, which leaves the electronic device screen unobstructed during use, thereby allowing users to simultaneously take notes and sketches on the refillable notepad.

16. The multi-functional padfolio of claim 1, wherein the rotatable holder comprises an elastomeric grip, wherein the grip is a silicon grip.

17. The multi-functional padfolio of claim 1, further comprises accessory holder, which is securely affixed on the inner surface of the front cover.

18. The multi-functional padfolio of claim 17, wherein the accessory holder is an elastic holder, wherein the cord holder is configured to securely hold at least one USB charging cable and/or wired earphones.

19. The multi-functional padfolio of claim 1, is made of a material includes at least any one of leather, PU leather, and animal friendly faux leather.

20. The multi-functional padfolio of claim 1, further comprises at least one built-in holder or pocket, wherein the built-in holder or pocket is configured to receive at least one journal or a planner.
